(19) United States
(12) Patent Application Publication
(10) Pub. No.: US 2011/0265326 A1
(43) Pub. Date: Nov. 3, 2011

(54) METHOD FOR MANUFACTURING SINGLE-PIECE FORGED-STEEL PISTON WITH INNER OIL COOLING CHAMBER

(76) Inventors: Fenghua LIN, Binzhou (CN); Qingyuan ZHANG, Binzhou (CN); Xuejun MA, Binzhou (CN); Feng ZHANG, Binzhou (CN)

(21) Appl. No.: 13/179,555

(22) Filed: Jul. 10, 2011

Related U.S. Application Data
(62) Division of application No. 12/175,588, filed on Jul. 18, 2008.

(30) Foreign Application Priority Data
Jul. 20, 2007 (CN) 200710015394.8
May 9, 2008 (CN) 200810099406.4

(51) Int. Cl. B23P 15/10

(52) U.S. Cl. 29/888.049

(57) ABSTRACT

A method for manufacturing piston with enclosed inner oil cooling chamber including 1) forging a blank of a piston body member and a blank of a piston ring member separately; 2) thermally treating the blank of the piston body member and the blank of the piston ring member separately; 3) sand blasting the blank of the piston body member and the blank of the piston ring member to form the inner cavity, the inner oil cooling chamber, and the laser welding surface; 4) welding the piston body member and the piston ring member together through laser welding procedure; 5) manufacturing the piston ring shaped groove, combustion chamber, ring groove, pinhole, outer circle, and the oil inlet/outlet holes, separately; and 6) phosphating or graphitizing the piston surface.

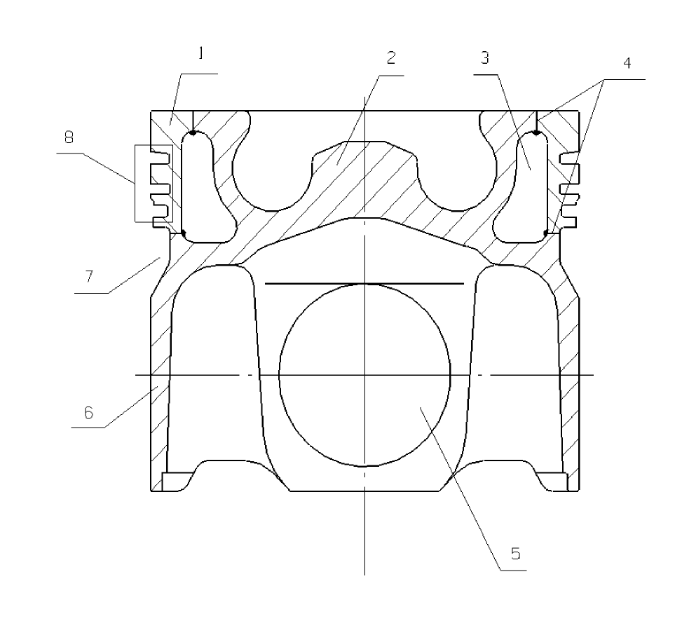

### CROSS-REFERENCE TO RELATED APPLICATIONS

This application is a divisional of U.S. Ser. No 12/175,588 filed on Jul. 18, 2008, now pending, which is based on Chinese Patent Application Number 200710015394.8 filed Jul. 20, 2007 and on Chinese Patent Application Number 200810099406.4 filed May 09, 2008. The contents of all of the aforementioned specifications are incorporated herein by reference.

### BACKGROUND OF THE INVENTION

1. Field of the Invention

The invention relates to a method for manufacturing a piston for an engine, and more particularly, to a method for manufacturing a laser-welded single-piece forged-steel piston with—inner oil cooling chamber.

2. Description of the Related Art

Currently, the development of engines for trucks, engineering machinery, locomotives, engine vessels, and so on, focuses on high power and heavy duty, resulting in higher requirements of rigidity and discharge levels. Although a conventional aluminum piston is light, it gradually fails to meet these demands. In diesel engines, high power and heavy duty pistons are realized by hinged pendulum type piston comprising a head and a skirt. The piston head and the piston skirt are manufactured separately, and are connected together by a piston pin. The piston head is usually made of cast iron or forged steel, while the piston skirt is made of aluminum material. However, the separate manufacture of the piston head and the piston skirt increases manufacturing cost. Moreover, an enclosed oil cooling chamber is difficult to form, resulting in poor cooling effect. Meanwhile, a long piston pin is often needed for connection, which increases the overall weight of the piston.

Chinese Pat. CN1610601A discloses a method for manufacturing forged steel piston, wherein the piston blank is a single piece and another separately manufactured ring cover is used for assembling with the ring shaped groove opened on the piston head to form an enclosed oil chamber. However, the manufacturing process is complicated, the manufacturing cost is high, and the structural strength of the piston leaves much to be desired.

Chinese Pat. No. CN2851607Y discloses another method for manufacturing forged steel piston, wherein the piston head and the piston skirt are forged and manufactured separately, and the inner oil cooling chamber is formed between the piston head and the piston skirt by means of friction welding Due to the limitations of the manufacturing process, equipment capability, and low manufacturing precision of friction welding, the uniformity of the friction welded pistons is poor, resulting in difference in piston weight and inner oil cooling chamber size formed by friction welding, thus, causing high scrap rate and influencing negatively engine performance. Moreover, the welding flash caused by friction welding is large (normally 4-8 mm), though the exposed welding flash can be processed and removed by a special process, the welding flash inside of the inner oil cooling chamber cannot be removed, negatively influencing the cooling effect of the piston. Accordingly, much opportunity for improvement in this area of technology remains.

### SUMMARY OF THE INVENTION

Therefore, it is one objective of the present invention to provide a laser welded single piece forged steel piston with an enclosed inner oil cooling chamber having a simple structure and relative easy manufacturing process and capable of satisfying the requirements of high power, high rigidity, and low discharge.

In order to realize the above objective, provided a laser-welded single-piece forged-steel piston with enclosed inner oil cooling chamber, comprising: a piston body member and a piston ring member, wherein the piston body member and the piston ring member are welded together through a laser welding procedure, and an inner oil cooling chamber is formed between the piston body member and the piston ring member.

The oil cooling chamber is connected with the inner cavity of the piston by at least two oil inlet and outlet holes, respectively.

When the piston is operating in the engine, the oil is sprayed into the piston inner cavity through the oil inlet holes, cycling inside of the ring cooling cavity, and flowing out from the oil outlet holes to take the heat away from the piston so as to decrease the operation temperature of the piston components and thereby to ensure the piston operation reliability.

A pin hole is opened at the lower portion of the piston body member.

Since the enclosed oil cooling chamber is formed through welding, the whole structural rigidity of the piston is increased, the working position of the piston especially the ring groove position is less deformed during operation, and thus, the hermetic sealing performance is increased and thereby the discharge of the engine is decreased

In a class of this embodiment or in another embodiment of the invention, the piston ring member is opened with at least one ring groove.

In a class of this embodiment or in another embodiment of the invention, the skirt portion of the piston body member is designed with a ring shaped groove.

In a class of this embodiment or in another embodiment of the invention, the laser welding position between the piston body member and the piston ring member are two ring shaped lines on the top and side of the piston body member, respectively, and can be adjusted according to different piston structure.

In accordance with the present invention, provided is a manufacturing process for manufacturing piston with enclosed inner oil cooling chamber, comprising the steps of:
1) forging the blank of piston body member and the blank of piston ring member separately;
2) thermally treating the blank of piston body member and the blank of piston ring member separately;
3) sand blasting the blank of piston body member and the blank of piston ring member to form the inner cavity, the inner oil cooling chamber, and the laser welding surface;
4) welding the piston body member and the piston ring member together through laser welding procedure;
5) manufacturing the piston ring shaped groove, combustion chamber, ring groove, pinhole, outer circle, and the oil inlet/outlet holes, separately; and
6) phosphating or graphitizing the piston surface.

In a class of this embodiment or in another embodiment of the invention, for thermal treating quenched and tempered steel, in the process in step 2) the temperature is kept at 800-850° C. for 1-2 hours and then the steel is oil cooled; the tempering temperature is 600° C. and the temperature holding time is 1.5-2.5 hours; for thermal treating of non-quenched and tempered steel, the process in step 2) the steel is air cooled directly to room temperature, namely, the temperature is decreased from 1100° C±50° C. after forging to 500° C±50° C. within 3-4 minutes.

In a class of this embodiment or in another embodiment of the invention, the laser welding process of step 4) comprises the steps of:
1) cleaning the welded position of the piston;
2) positioning the piston;
3) welding the piston with CO2 laser, the laser output power of 2000W-7000W, the focal length of the focusing mirror is f=70-150 mm, and the welding linear speed is 0.5-2 m/minute;
4) applying twice the welding process to ensure welding uniformity, wherein the first one is a quick tack welding, the laser power is 2000 W-7000 W and the welding speed is 2-4 m/min, and the second one is deep penetration welding, the laser power is 2000-7000 W and the welding speed is 0.5-2 m/minute; and
5) laser annealing the welding lines to improve their strength and subsequent manufacturability.

In a class of this embodiment or in another embodiment of the invention, the ring shaped groove processed at the upper portion of the piston skirt contributes not only to the decrease of the overall piston weight, but also improved and facilitates oil return in the oil ring groove. Meanwhile, the flexibility of the skirt portion is increased, contributing to the decrease of the clearance between the piston and the cylinder and the decrease of oil consumption.

In a class of this embodiment or in another embodiment of the invention, two recesses are opened at two sides of the piston pin hole, so that, given a required piston strength, the overall weight of the piston is decreased. To avoid the position of the oil injection nozzle installed on the engine body, a notch is designed at the lower portion of the piston skirt to avoid the interference of the piston with the oil injection nozzle when the piston is moving to the bottom dead center.

In a class of this embodiment or in another embodiment of the invention, distinguishing from the method disclosed by Chinese Pat. CN1610601A, the piston head and the piston skirt of the present invention are forged separately, the inner oil cooling chamber is formed through laser welding procedure the piston head and the piston skirt together, so that the processes of forging the piston blank and forming the enclosed oil chamber are simplified and the structural strength of the piston is improved. The forged steel piston disclosed by Chinese Pat. CN1610601A is not a welded but an assembled structure, its most serious drawback is that the rigidity of the piston is poor, and the manufacturing process is complicated.

The welding method for manufacturing forged-steel piston disclosed in Chinese Pat. CN2851607Y is friction welding. Compared with the friction welding, the laser welding utilized in embodiments of the present invention has the advantage of precise control on laser welding dimension. Moreover, the length of the piston of the present invention will not change after welding, so that the processes for the forging of piston blank and the formation of enclosed oil chamber are simplified, and the structural strength of the piston is improved. The welding flash is reduced and the piston is less deformed, the piston material is saved, and the dimension consistency (to ensure consistency of cooling effect) of the inner oil cooling chamber and the uniformity of the piston weight are ensured. The method of the invention thereby provides a lower production scrap rate, and is suitable for mass production.

As a result, the forged steel piston of the present invention can not only replace the conventional aluminum piston, hinged piston, friction welded forged steel piston, but also offers light weight and higher strength to satisfy the rigidity and discharge requirement of the engine, and good manufacturability.

### BRIEF DESCRIPTION OF THE DRAWINGS

The single figure illustrates a structural view of a forged steel piston in accordance with one embodiment the invention, wherein the piston ring member corresponds to the number 1; piston body member—2; inner oil cooling chamber—3; laser welding position—4; pin hole—5; piston skirt portion—6; ring shaped groove—7; ring groove—8.

### DETAILED DESCRIPTION OF THE EMBODIMENTS

The present invention will hereinafter be described further according to the embodiments.

### Example 1

As shown in the figure, the piston body member 2 and the piston ring member 1 are forged separately, and are welded together through laser welding procedure. One or more ring grooves 8 are formed on the outer surface of the piston ring member 1. The laser welding position 4 between the piston body member 2 and the piston ring member 1 are two ring-shaped welding lines on the top and side of the piston body member 2, respectively. An inner oil cooling chamber 3 is formed between the piston ring member 1 and the piston body member 2 after welding. The inner oil cooling chamber 3 is connected with the piston inner cavity by means of two or three oil inlet and outlet holes. A ring shaped groove 7 is processed at the skirt portion of the piston body member 2. A pin hole 5 is opened at the lower portion of the piston body member 2, and two recesses are processed at the two sides of the pin hole 5, respectively.

In accordance with the present invention, a manufacturing process for forged steel piston with enclosed inner oil cooling chamber comprises the steps of:
1) forging the piston body member and the piston ring member separately, which can be made of forgeable quenched and tempered steel or non-quenched and tempered steel;
2) thermal treating the blank of the piston body member and the blank of the piston ring member, wherein the process for thermal treating quenched and tempered steel comprises holding the temperature at 830° C. for 1.5 hours first and then oil cooling, the tempering temperature is 600° C. and the temperature holding time is 2 hours, and that for thermal treating non-quenched and tempered steel is air cooling directly to room temperature with an ensured condition that the temperature must be decreased from about 1100° C. after forging to 500° C. within 3.5 minutes critically;
3) sand blasting the blank of piston body member and the blank of the piston ring member to manufacture the inner cavity, inner oil cooling chamber, and the laser welding surface;
4) welding the piston body member and the piston ring member together through laser welding procedure;
5) processing separately the parts such as the piston ring shaped groove, combustion chamber, ring groove, pin hole, outer circle, oil inlet/outlet holes, etc;
6) phosphating or graphitizing the surface of the piston.

In accordance with the first embodiment of the invention, the laser welding procedure of step 4) comprises further the steps of:
1) cleaning the welding position of the piston;
2) positioning the piston;
3) welding the piston with CO₂ laser, the laser output power is 2600 W, the focal length of the focusing mirror is f=100 mm, and the welding linear speed is 1 m/minute;
4) two-pass welding to ensure welding uniformity, wherein the first pass is quick tack welding, the laser power is 2600W, and the welding speed is 3 m/min; the second pass is deep penetration welding, the laser power is 2600W, and the welding speed is 1 m/minute; and
5) laser annealing the welding line to improve its strength and the subsequent manufacturability.

Example 1 illustrates a structural configuration of a laser welded single piece forged steel piston with an enclosed inner oil cooling chamber of the invention, the structure and specific dimensions (including but not limited to the position and quantity of welding lines) can be changed and adjusted according to demand.

### Example 2

The structure of the piston in example 2 is the same as that of the piston in example 1. The manufacturing process comprises the steps of:
1) forging separately the blank of piston body member and the blank of piston ring member;
2) thermal-treating separately the blank of piston body member and the blank of piston ring member;
3) sand blasting the blank of piston body member and the blank of piston ring member to manufacture the inner cavity, inner oil cooling chamber, and the laser welding surface;
4) welding the piston body member and the piston ring member together through laser welding procedure;
5) processing separately the piston ring shaped groove, combustion chamber, ring groove, pin hole, outer circle, and the oil inlet/outlet holes;
6) phosphating or graphitizing the surface of the piston.

In accordance with the second example, the process for thermal treating quenched and tempered steel comprises holding the temperature at 800° C. for 1 hour first and then oil cooling, the tempering temperature is 590° C. and the temperature holding time is 1.5 hours; and the process for thermal treating non-quenched and tempered steel is air cooling directly to room temperature with an ensured condition that the temperature must be decreased from about 1050° C. after forging to 450° C. within 3 minutes.

In accordance with the second example, the laser welding procedure of step 4) comprises the steps of:
1) cleaning the welding position of the piston;
2) positioning the piston;
3) welding the piston with CO2 laser, the laser output power is 2000 W, the focal length of the focusing mirror is f=70 mm, and the welding linear speed is 0.5 m/minute;
4) applying a two-pass welding process to ensure welding uniformity, wherein the first pass is a quick tack welding, the laser power is 2000 W, and the welding speed is 2 m/min; the second pass is deep penetration welding, the laser power is 2000 W, and the welding speed is 0.5 m/minute; and
5) laser annealing the welding line to improve its strength and subsequent manufacturability.

### Example 3

The structure of the piston in Example 3 is the same as that of the piston in Example 1, manufactured by the steps of:
1) forging separately the blank of piston body member and the blank of piston ring member;
2) thermally treating separately the blank of piston body member and the blank of piston ring member;
3) sand blasting the blank of piston body member and the blank of piston ring member to manufacture the inner cavity, inner oil cooling chamber, and the laser welding surface;
4) welding the piston body member and the piston ring member using a laser welding process;
5) processing separately the piston ring shaped groove, combustion chamber, ring groove, pin hole, outer circle, and the oil inlet/outlet holes; and
6) phosphating or graphitizing the surface of the piston.

In accordance with the third example of the invention, the process for thermal treating quenched and tempered steel comprises holding the temperature at 850° C. for 2 hours first and then oil cooling, the tempering temperature is 610° C. and the temperature holding time is 2.5 hours; and the process for thermal treating non-quenched and tempered steel comprises air cooling directly to room temperature with an ensured condition that the temperature must be decreased from about 1150° C. to 550° C. within 4 minutes.

In accordance with the third example of the invention, the laser welding procedure of step 4) comprises the steps of:
1) cleaning the welding position of the piston;
2) positioning the piston;
3) welding the piston with CO₂ laser, wherein the laser output power is 7000 W, the focal length of the focusing mirror is f=150 mm, the welding linear speed is 2 m/minute;

4) applying a two-pass welding process to ensure welding uniformity, wherein the first pass is quick tack welding, the laser power is 7000 W, the welding speed is 4 m/min; and the second pass is deep penetration welding, the laser power is 7000 W, the welding speed is 2 m/minute; and
5) laser annealing the welding line to improve its strength and subsequent manufacturability.

This invention is not to be limited to the specific embodiments disclosed herein and modifications for various applications and other embodiments are intended to be included within the scope of the appended claims. While this invention has been described in connection with particular examples thereof, the true scope of the invention should not be so limited since other modifications will become apparent to the skilled practitioner upon a study of the drawings, specification, and following claims.

All publications and patent applications mentioned in this specification are indicative of the level of skill of those skilled in the art to which this invention pertains. All publications and patent applications mentioned in this specification are herein incorporated by reference to the same extent as if each individual publication or patent application mentioned in this specification was specifically and individually indicated to be incorporated by reference.

The invention claimed is:

1. A method for manufacturing a piston, said piston comprising as a single piece:
a piston body member (2),
a piston ring member (1),
an inner oil cooling chamber (3),
at least two oil inlet and outlet holes, and
a pin hole;
wherein
said piston body member (2) and said piston ring member (1) are made of forged-steel and are welded together using laser welding;
an inner oil cooling chamber (3) is formed between said piston body member (2) and said piston ring member (1);
said inner oil cooling chamber (3) is connected with the piston inner cavity by means of at least two oil inlet/outlet holes; and
a pin hole (5) is opened in said piston body member (2);
said method comprising the steps of:
1) forging a blank of said piston body member and a blank of said piston ring member separately;
2) heat treating said blank of said piston body member and said blank of said piston ring member separately;
3) sand blasting said blank of said piston body member and said blank of said piston ring member to form an inner cavity, said inner oil cooling chamber, and a laser welding surface;
4) laser welding said piston body member and said piston ring member together;
5) manufacturing the piston ring shaped groove, combustion chamber, ring groove, pinhole, outer circle, and the oil inlet/outlet holes, separately; and
6) phosphating or graphitizing the piston surface.

2. The method of claim 1, wherein the heat treating process of step 2) comprises
for treating quenched and tempered steel, first holding the temperature at 800-850° C. for 1-2 hours and then oil cooling to a temperature of 600° C±10° C., for 1.5-2.5 hours; or
for treating non-quenched and tempered steel, air cooling from a temperature of 1100° C±50° C. to 500° C±50° C. within 3-4 minutes.

3. The method of claim 1, wherein the laser welding of said step 4) comprises the steps of:
1) cleaning the welding position of the piston;
2) positioning the piston;
3) welding the piston with CO₂ laser, the laser output power being 2000W-7000W, the focal length of the focusing mirror being f=70-150 mm, and the welding linear speed being 0.5-2 m/minute;
4) two-pass welding, wherein the first pass is a quick tack welding, the laser power being 2000W-7000W and the welding speed being 2-4 m/min; and
the second pass is deep penetration welding, the laser power being 2000-7000W and the welding speed being 0.5-2 m/minute; and
5) laser annealing to improve weld strength and subsequent manufacturability.

4. A method for manufacturing a piston, said piston comprising as a single piece:
a piston body member (2),
a piston ring member (1),
an inner oil cooling chamber (3),
at least two oil inlet and outlet holes, and
a pin hole;
wherein
said piston body member (2) and said piston ring member (1) are made of forged-steel and are welded together using laser welding;
an inner oil cooling chamber (3) is formed between said piston body member (2) and said piston ring member (1);
said inner oil cooling chamber (3) is connected with the piston inner cavity by means of at least two oil inlet/outlet holes; and
a pin hole (5) is opened in said piston body member (2);
said method comprising the steps of:
1) forging a blank of said piston body member and a blank of said piston ring member separately;
2) heat treating said blank of said piston body member and said blank of said piston ring member separately, wherein
a) for treating quenched and tempered steel, first holding the temperature at 800-850° C. for 1-2 hours and then oil cooling to a temperature of 600° C±10° C., for 1.5-2.5 hours; or
b) for treating non-quenched and tempered steel, air cooling from a temperature of 1100° C±50° C. to 500° C±50° C. within 3-4 minutes;
3) sand blasting said blank of said piston body member and said blank of said piston ring member to form an inner cavity, said inner oil cooling chamber, and a laser welding surface;
4) laser welding said piston body member and said piston ring member together, wherein:
a) cleaning the welding position of the piston;
b) positioning the piston;
c) welding the piston with CO₂ laser, the laser output power being 2000W-7000W, the focal length of the focusing mirror being f=70-150 mm, and the welding linear speed being 0.5-2 m/minute;
d) two-pass welding, wherein the first pass is a quick tack welding, the laser power being 2000W-7000W and the welding speed being 2-4 m/min; and the second pass is deep penetration welding, the laser power being 2000-7000W and the welding speed being 0.5-2 m/minute; and
e) laser annealing to improve weld strength and subsequent manufacturability;
5) manufacturing the piston ring shaped groove, combustion chamber, ring groove, pinhole, outer circle, and the oil inlet/outlet holes, separately; and
6) phosphating or graphitizing the piston surface.
